(19) United States
(12) Patent Application Publication
(10) Pub. No.: US 2019/0135073 A1
(43) Pub. Date: May 9, 2019

(54) AIR CONDITIONER FOR A VEHICLE

(71) Applicant: TOYOTA JIDOSHA KABUSHIKI KAISHA, Toyota-shi (JP)

(72) Inventor: Shota Higashihara, Chiryu-shi (JP)

(73) Assignee: TOYOTA JIDOSHA KABUSHIKI KAISHA, Toyota-shi (JP)

(21) Appl. No.: 16/176,202

(22) Filed: Oct. 31, 2018

(30) Foreign Application Priority Data
Nov. 7, 2017 (JP) 2017-214902

(51) Int. Cl. B60H 1/00

(52) U.S. Cl. CPC B60H 1/00742; B60H 2001/003; B60H 1/00285

(57) ABSTRACT

A vehicle air conditioner blows conditioned air towards interior finishing materials of a vehicle prior to a vehicle occupant boarding the vehicle. Consequently, the interior finishing materials can be cooled or warmed before a vehicle occupant boards the vehicle. Alternatively, when a vehicle occupant has boarded the vehicle, conditioned air is blown towards the vehicle occupant who has boarded the vehicle. Accordingly, air can be blown directly onto a vehicle occupant at the same time as hot or cold sensations imparted from the interior finishing materials to the vehicle occupant are reduced.

### CROSS-REFERENCE TO RELATED APPLICATION

This application is based on and claims priority under 35 USC 119 from Japanese Patent Application No. 2017-214902 filed on Nov. 7, 2017, the disclosure of which is incorporated by reference herein.

### TECHNICAL FIELD

The present disclosure relates to an air conditioner for a vehicle.

### RELATED ART

An air conditioner for a vehicle that blows small jets of air directly towards an area around the face of a vehicle occupant for a predetermined time, and then, in addition to these direct air jets, blows conditioned air from diffuser outlets so as to cool contact portions between the vehicle occupant and interior finishing materials is disclosed in Japanese Unexamined Patent Application (JP-A) No. 2006-76503 (Patent Document 1).

When, for example, during summer, a vehicle air conditioner is operated in cooling mode, by blowing air towards a vehicle occupant on board the vehicle, the peripheral temperature (i.e., the air temperature) around that vehicle occupant can quickly be lowered. However, if air is blown towards a vehicle occupant, then it is difficult to cool down the interior finishing materials such as the roof and door trims and the like, so there are cases when the vehicle occupant feels radiant heat from the interior finishing materials.

Here, in a structure in which the interior finishing materials are cooled down after the vehicle occupant has boarded the vehicle, as is the case with the vehicle air conditioner described in Patent Document 1, because the vehicle occupant boards the vehicle before the temperature of the interior finishing materials has cooled, this structure provides only a small effect towards reducing the hot sensation created by the radiant heat from the interior finishing materials. The same effect occurs during winter as well when the vehicle air conditioner is operated in heating mode, namely, the structure described in Patent Document 1 provides only a small effect towards reducing the cold sensation imparted to a vehicle occupant from the interior finishing materials.

### SUMMARY

The present disclosure was conceived in view of the above-described circumstances and it is an object thereof to provide an air conditioner for a vehicle that is able to quickly adjust the peripheral temperature around a vehicle occupant, while reducing hot or cold sensations imparted to the vehicle occupant from the interior finishing materials.

An air conditioner for a vehicle according to a first aspect is provided with an air conditioner unit that is configured to execute first air conditioning in which air is blown towards a vehicle occupant who has boarded a vehicle, and second air conditioning in which air is blown towards interior finishing materials of the vehicle, and with a control unit that causes the air conditioner unit to execute the first air conditioning in a first case, which is when a vehicle occupant has boarded the vehicle, and causes the air conditioner unit to execute the second air conditioning in a second case, which is when no vehicle occupant has boarded in the vehicle.

According to the air conditioner for a vehicle according to the first aspect, in a second case, which is when no vehicle occupant has boarded a vehicle, an air conditioner unit executes second air conditioning in which air is blown towards interior finishing materials of the vehicle. Because of this, the interior finishing materials can be cooled or heated before a vehicle occupant boards the vehicle. By heating or cooling the interior finishing materials before a vehicle occupant boards the vehicle, it is possible to reduce the hot or cold sensation (i.e., either a hot sensation or a cold sensation) imparted from the interior finishing materials to a vehicle occupant when they board the vehicle.

Furthermore, in the air conditioner for a vehicle according to the first aspect, in a first case, which is when a vehicle occupant has boarded a vehicle, the air conditioner unit executes first air conditioning in which air is blown towards the vehicle occupant who has boarded the vehicle. Because of this, compared with when air is blown in a direction where there is no vehicle occupant, the peripheral temperature around a vehicle occupant can be quickly adjusted.

Consequently, according to the air conditioner for a vehicle according to the first aspect, the peripheral temperature around a vehicle occupant can be quickly adjusted at the same time as a hot or cold sensation imparted from the interior finishing materials to a vehicle occupant is reduced.

In the air conditioner for a vehicle according to a second aspect, in the first case, the control unit causes the air conditioner unit to execute the first air conditioning when the vehicle interior temperature meets predetermined temperature conditions, and when the vehicle interior temperature does not meet predetermined temperature conditions in the first case, the control unit causes the air conditioner unit to execute one of the first air conditioning or the second air conditioning based on a selection made by a vehicle occupant, while in the second case, the control unit causes the air conditioner unit to execute the second air conditioning irrespective of the vehicle interior temperature.

According to the air conditioner for a vehicle according to the second aspect, when the vehicle interior temperature meets temperature conditions that do not require the first air conditioning in which air is blown towards a vehicle occupant to be executed, either the first air conditioning or the second air conditioning can be selected by a vehicle occupant and then executed. Moreover, in the second case in which no vehicle occupant has boarded the vehicle, the second air conditioning can be executed without relying on detection results from a detection unit (i.e., a temperature sensor or the like) that detects the vehicle interior temperature.

In the air conditioner for a vehicle according to a third aspect, when an operation to drive the air conditioner unit has been performed outside a vehicle, the control unit causes the air conditioner unit to execute, as the second case, the second air conditioning.

According to the air conditioner for a vehicle according to the third aspect, when an operation to drive the air conditioner unit has been performed outside a vehicle, the air conditioner unit executes the second air conditioning as the second case. In other words, when an operation to drive the air conditioner unit has been performed on the outside of a vehicle, then it is assumed that no vehicle occupant has boarded the vehicle and the air conditioner unit executes the second air conditioning. Accordingly, the air conditioner unit executes the second air conditioning without relying on detection results from a detecting unit (i.e., a seating sensor or the like) indicating that no vehicle occupant has boarded the vehicle.

In the air conditioner for a vehicle according to a fourth aspect, the air conditioner unit executes the first air conditioning and the second air conditioning using power from a secondary cell that is provided in a vehicle, and when the secondary cell is being charged, the control unit causes the air conditioner unit to execute, as the second case, the second air conditioning.

According to the air conditioner for a vehicle according to the fourth aspect, when the secondary cell is being charged, the air conditioner unit executes the second air conditioning as the second case. In other words, when the secondary cell is being charged, it is assumed that no vehicle occupant has boarded the vehicle so that the air conditioner unit executes the second air conditioning.

Here, according to the air conditioner for a vehicle according to the fourth aspect, because the second air conditioning is executed while the secondary cell provided in the vehicle is being charged, the power of the secondary cell that has been consumed by the execution of the second air conditioning can be replenished. Because of this, even if the vehicle in which the air conditioner for a vehicle has been applied is an electric vehicle that runs on power stored in a secondary cell, there is no effect on the travel distance of this vehicle.

In the air conditioner for a vehicle according to a fifth aspect, in the second air conditioning, the air conditioner unit blows air in a different blowing direction from the blowing direction employed in the first air conditioning.

According to the air conditioner for a vehicle according to the fifth aspect, in the second air conditioning, it is possible to cool or heat interior finishing materials disposed in a different direction from the sitting position in the vehicle where the vehicle occupant is sitting.

In the air conditioner for a vehicle according to a sixth aspect, the air conditioner unit has altering components that, in the second air conditioning, alter the wind direction to a different blowing direction from the blowing direction employed in the first air conditioning.

According to the air conditioner for a vehicle according to the sixth aspect, in the second air conditioning, the altering components alter the wind direction to a different blowing direction from the blowing direction employed in the first air conditioning.

Here, if altering components are not provided, because it then becomes necessary to blow air in the first air conditioning from an air ventilation port facing in a different direction from an air ventilation port employed in the second air conditioning, it becomes necessary to provide both an air ventilation port for the first air conditioning and an air ventilation port for the second air conditioning.

In contrast to this, in the air conditioner for a vehicle according to the sixth aspect, because the altering components alter the wind direction to a different blowing direction from the blowing direction employed in the first air conditioning, air can be blown from the same air ventilation port in both the first air conditioning and the second air conditioning.

Because the present disclosure has the above described structure, the excellent effect is obtained that the peripheral temperature around a vehicle occupant can be quickly adjusted at the same time as a hot or cold sensation imparted from the interior finishing materials to a vehicle occupant is reduced.

### BRIEF DESCRIPTION OF THE DRAWINGS

Exemplary embodiments of the present disclosure will be described in detail based on the following figures, wherein:

FIG. 1 is a view showing both schematically and conceptually a vehicle in which an air conditioner for a vehicle according to the present exemplary embodiment has been applied;

FIG. 2 is a side view showing a vehicle interior when first air conditioning in which air is blown towards a vehicle occupant is being executed in the air conditioner for a vehicle according to the present exemplary embodiment;

FIG. 3 is a side view showing a vehicle interior when second air conditioning in which air is blown towards interior finishing materials is being executed in the air conditioner for a vehicle according to the present exemplary embodiment;

FIG. 4 is a block diagram showing the structure of the air conditioner for a vehicle according to the present exemplary embodiment;

FIG. 5 is a perspective view showing a vehicle interior when the first air conditioning in which air is blown towards a vehicle occupant is being executed in the air conditioner for a vehicle according to the present exemplary embodiment;

FIG. 6 is a perspective view showing a vehicle interior when second air conditioning in which air is blown towards interior finishing materials is being executed in the air conditioner for a vehicle according to the present exemplary embodiment;

FIG. 7 is a view showing the structure of an seat air conditioner unit according to the present exemplary embodiment, and is a cross-sectional view taken in a horizontal direction along a branch path of a duct of the seat conditioning unit showing a seat back of a driver's seat;

FIG. 8 is a table showing blowing directions of each diffuser outlet in the first air conditioning;

FIG. 9 is a table showing blowing directions of each diffuser outlet in the second air conditioning; and

FIG. 10 is a table showing relationships between a vehicle state and vehicle interior temperature, and a type of air conditioning that is selected.

### DETAILED DESCRIPTION

Hereinafter, an example of an exemplary embodiment according to the present disclosure will be described based on the drawings. A vehicle 100 in which an air conditioner 10 for a vehicle according to the present exemplary embodiment has been applied, the air conditioner 10 for a vehicle, and each portion of the air conditioner 10 for a vehicle is described below.

Note that an arrow RR, an arrow UP, and an arrow RH that are shown in the appropriate drawings respectively indicate a rear side, an upper side, and a right side of a vehicle. Hereinafter, if simple front-rear, left-right, and up-down directions are used in the following description, then these respectively refer to the front-rear directions of a vehicle, the left-right directions of a vehicle (i.e., the vehicle width direction), and the up-down directions of a vehicle.

(Vehicle 100 in which an Air Conditioner 10 for a Vehicle has been Applied)

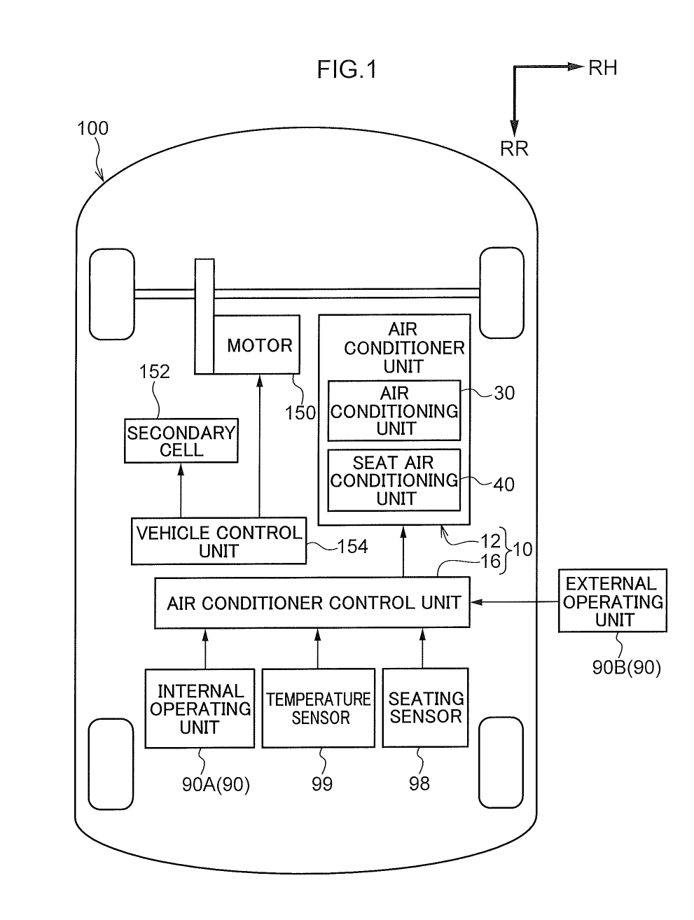

FIG. 1 is a view showing both schematically and conceptually a vehicle 100 in which an air conditioner 10 for a vehicle has been applied.

As an example, the vehicle 100 in which an air conditioner 10 for a vehicle has been applied is an electric vehicle (EV) that uses electricity as a source of motive power. As is shown in FIG. 1, the vehicle 100 has a motor (i.e., an electric motor) 150, a secondary cell 152, and a vehicle control unit 154. In the vehicle 100, the secondary cell 152 is charged using power supplied from an external source, and the vehicle 100 runs by driving the motor 150 using power stored in the secondary cell 152. The driving of the motor 150 is controlled by the vehicle control unit 154.

(Air Conditioner 10 for a Vehicle)

The air conditioner 10 for a vehicle is a device that regulates the interior air temperature of the vehicle 100. As is shown in FIG. 1, the air conditioner 10 for a vehicle is provided with an air conditioner unit 12 and an air conditioner control unit 16. Hereinafter, the specific structures of the air conditioner unit 12 and the air conditioner control unit 16 will be described.

(Air Conditioner Unit 12)

The air conditioner unit 12 is an example of an air conditioner unit that is capable of executing both first air conditioning in which air is blown towards a vehicle occupant who has boarded a vehicle, and second air conditioning in which air is blown towards interior finishing materials of the vehicle.

This air conditioner unit 12 has a structure that enables it to both cool and heat the interior of the vehicle 100. Specifically, the air conditioner unit 12 is structured so as to generate either cool air or warm air (hereinafter, referred to as ‘conditioned air’), and blow this conditioned air into the vehicle interior.

In the present exemplary embodiment, as is shown in FIG. 1, the air conditioner unit 12 has an air conditioning unit 30 and a seat air conditioning unit 40.

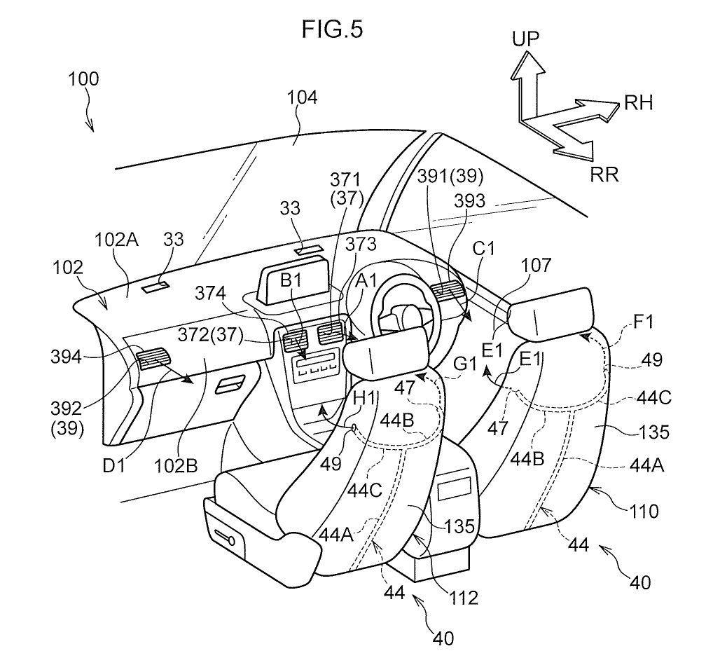

The air conditioning unit 30 is an air conditioning unit that blows conditioned air into a vehicle interior from air ventilation ports (i.e., defroster diffuser outlets 33, center register diffuser outlets 37, and side register diffuser outlets 39) provided in an instrument panel 102 shown in FIG. 5.

The seat air conditioning unit 40 is an air conditioning unit that blows conditioned air into a vehicle interior from ventilation ports (i.e., inner side diffuser outlets 47 and outer side diffuser outlets 49) provided in a driver's seat 110 (see FIG. 5) and a front passenger's seat 112 (see FIG. 5) serving as vehicle seats. Hereinafter, specific structures of the air conditioning unit 30 and the seat air conditioning unit 40 will be described.

(Air conditioning unit 30) The air conditioning unit 30 generates conditioned air and then blows a portion of this conditioned air into the vehicle interior, and supplies another portion of the conditioned air to the seat air conditioning unit 40.

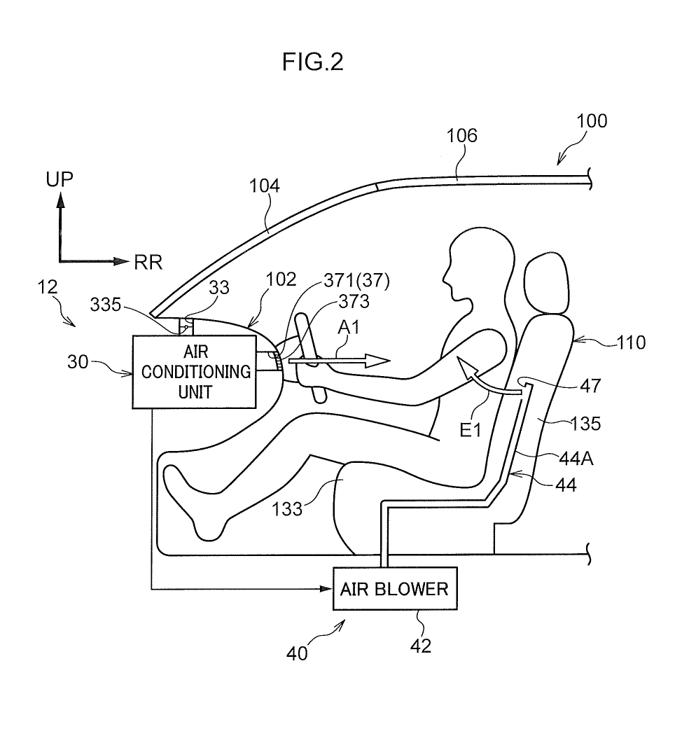

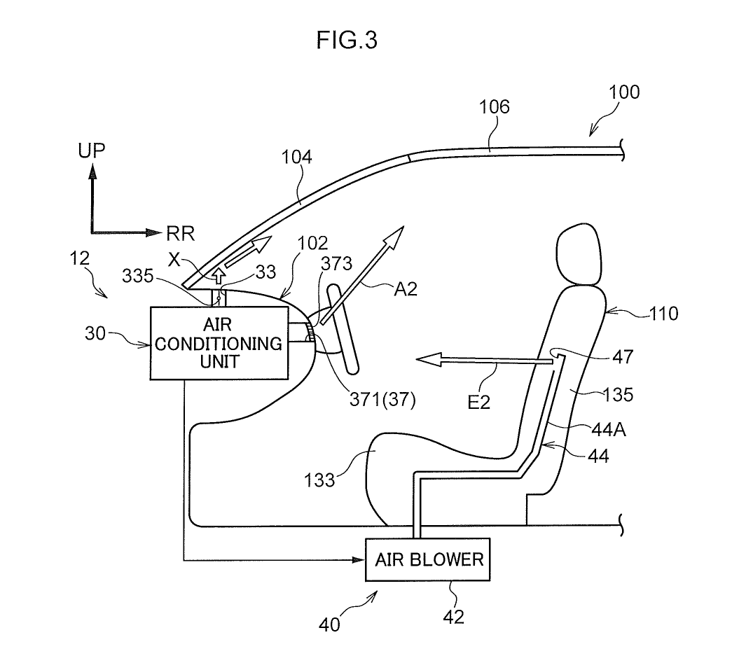

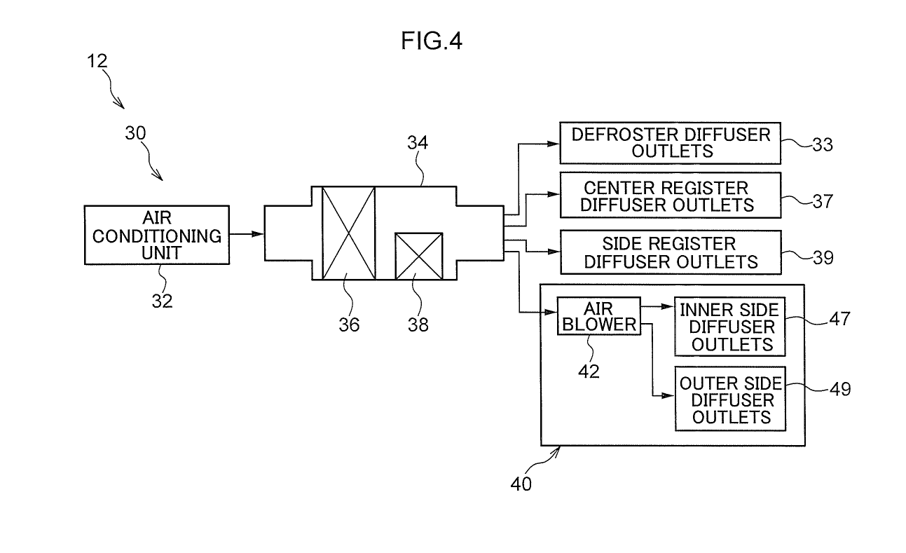

As is shown in FIG. 2 and FIG. 3, the air conditioning unit 30 is provided inside the instrument panel 102 (i.e., the dashboard). Specifically, as is shown in FIG. 4, the air conditioning unit 30 has an air blower 32, a duct 34, a cooling unit 36, a heating unit 38, the defroster diffuser outlets 33, the center register diffuser outlets 37, and the side register diffuser outlets 39.

The air blower 32 is disposed upstream from the duct 34. The air blower 32 blows air which it has taken in from at least one of the vehicle interior and the vehicle exterior. As an example, a centrifugal air blower which blows air in centrifugal directions such as a multi vane fan (for example, a sirocco fan) is used as the air blower 32. Note that it is also possible for an axial air blower which blows air in an axial direction to be used as the air blower 32.

The duct 34 functions as a flow path that distributes the wind (i.e., the airflow) generated by the air blower 32. A downstream portion of the duct 34 communicates with the defroster diffuser outlets 33, the center register diffuser outlets 37, and the side register diffuser outlets 39. Additionally, the downstream portion of the duct 34 is also connected to an air blower 42 (described below) of the seat air conditioning unit 40.

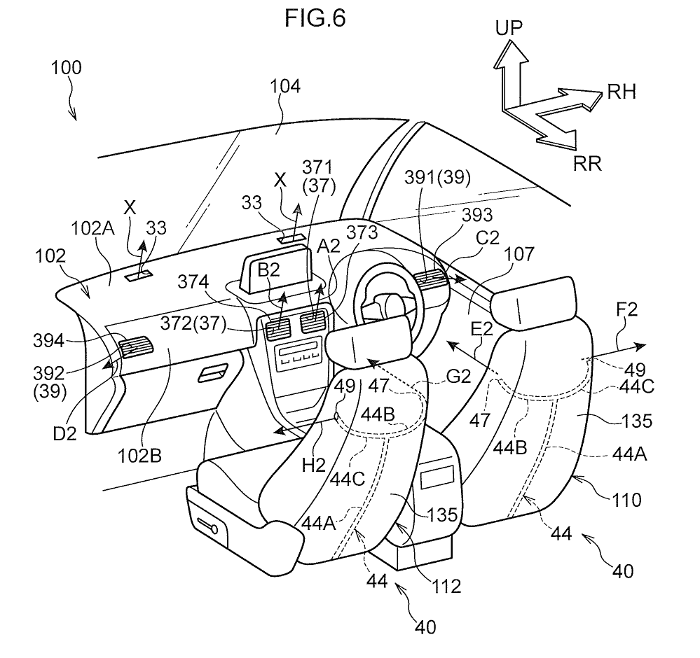

As is shown in FIG. 5 and FIG. 6, the defroster diffuser outlets 33 are disposed in an upper wall portion 102A of the instrument panel 102 which faces towards a front windshield glass 104 (hereinafter, referred to as a ‘front glass 104’). In other words, the defroster diffuser outlets 33 open in the vehicle upward direction towards the front glass 104. The defroster diffuser outlets 33 blow conditioned air in the vehicle upward direction (i.e., in the directions indicated by arrows X in FIG. 3 and FIG. 6) towards the front glass 104, which is serving as an interior finishing material of the vehicle 10.

As is shown in FIG. 2 and FIG. 3, an opening/closing portion 335 which is able to open and close the defroster diffuser outlets 33 is provided in the defroster diffuser outlets 33. As is shown in FIG. 3, when the defroster diffuser outlets 33 are opened by the opening/closing portions 335, conditioned air is blown upwards (i.e., in the directions indicated by the arrows X in FIG. 3 and FIG. 6) from the defroster diffuser outlets 33. In contrast, as is shown in FIG. 2, when the defroster diffuser outlets 33 are closed by the opening/closing portions 335, the blowing of conditioned air from the defroster diffuser outlets 33 is stopped (see FIG. 2 and FIG. 5).

As is shown in FIG. 5 and FIG. 6, the center register diffuser outlets 37 are disposed in a central portion in the vehicle width direction of a rear wall portion 102B of the instrument panel 102 which faces towards the vehicle rear side. Accordingly, the center register diffuser outlets 37 open towards the vehicle rear side. These center register diffuser outlets 37 are formed as a pair. More specifically, the pair of center register diffuser outlets 37 are formed by a first center register diffuser outlet 371 which is disposed on the driver's seat 110 side (i.e. on the vehicle right side in the present exemplary embodiment), and a second center register diffuser outlet 372 which is disposed on the front passenger's seat 112 side (i.e. on the vehicle left side in the present exemplary embodiment).

Wind direction flaps 373 and 374 which are able to alter wind direction are provided in the first center register diffuser outlet 371 and the second center register diffuser outlet 372. The first center register diffuser outlet 371 is able to switch the wind direction using the wind direction flaps 373 between a first direction (i.e., a direction indicated by an arrow A1 in FIG. 2 and FIG. 5) in which air is blown towards a vehicle occupant seated in the driver's seat 110, and a second direction (i.e., a direction indicated by an arrow A2 in FIG. 3 and FIG. 6) in which air is blown in the vehicle upward direction towards a roof 106 (see FIG. 3), which is serving as an interior finishing material of the vehicle 100.

The second center register diffuser outlet 372 is able to switch the wind direction using the wind direction flaps 374 between a first direction (i.e., a direction indicated by an arrow B1 in FIG. 5) in which air is blown towards a vehicle occupant seated in the front passenger's seat 112, and a second direction (i.e., a direction indicated by an arrow B2 in FIG. 6) in which air is blown in the vehicle upward direction towards the roof 106 (see FIG. 3).

The side register diffuser outlets 39 are disposed at both end portions in the vehicle width direction of the rear wall portion 102B of the instrument panel 102. Accordingly, the side register diffuser outlets 39 open towards the vehicle rear side. These side register diffuser outlets 39 are formed as a pair. More specifically, the pair of side register diffuser outlets 39 are formed by a first side register diffuser outlet 391 which is disposed on the driver's seat 110 side (i.e. on the vehicle right side in the present exemplary embodiment), and a second side register diffuser outlet 392 which is disposed on the front passenger's seat 112 side (i.e. on the vehicle left side in the present exemplary embodiment).

Wind direction flaps 393 and 394 which are able to alter wind direction are provided in the first side register diffuser outlet 391 and the second side register diffuser outlet 392. The first side register diffuser outlet 391 is able to switch the wind direction using the wind direction flaps 393 between a first direction (i.e., a direction indicated by an arrow C1 in FIG. 5) in which air is blown towards a vehicle occupant seated in the driver's seat 110, and a second direction (i.e., a direction indicated by an arrow C2 in FIG. 6) in which air is blown in the vehicle right side direction towards a vehicle right side door trim 107.

The second side register diffuser outlet 392 is able to switch the wind direction using the wind direction plates 394 between a first direction (i.e., a direction indicated by an arrow D1 in FIG. 5) in which air is blown towards a vehicle occupant seated in the front passenger's seat 112, and a second direction (i.e., a direction indicated by an arrow D2 in FIG. 6) in which air is blown in the vehicle left side direction towards a vehicle left side door trim 107.

The cooling unit 36 shown in FIG. 4 has a function of cooling air that has been fed from the air blower 32 and is being distributed through the duct 34. More specifically, the cooling unit 36 is formed such that it cools air that is being distributed through the duct 34 using a heat pump cycle (i.e., a refrigeration cycle) that causes a refrigerant to circulate while simultaneously compressing (i.e. pressurizing) and expanding (i.e. depressurizing) the refrigerant. In other words, by performing a heat exchange between the refrigerant circulating through the heat pump cycle and the air inside the duct 34, the air being distributed through the duct 34 is cooled.

The heating unit 38 shown in FIG. 4 has a function of heating (i.e. warming) air that has been fed from the air blower 32 and is being distributed through the duct 34. As an example, an electric heater utilizing electric heat (i.e., Joule heat) is used as the heating unit 38. For example, a PTC (Positive Temperature Coefficient) heater is used as the electric heater.

As an example, the heating unit 38 is formed such that it directly heats the air being distributed through the duct 34. Note that the heating unit 38 may also be formed such that it heats a heating medium such as water, and then warms the air indirectly via this heating medium.

Furthermore, it is also possible for a structure in which the air being distributed through the duct 34 is heated using the above-described heat pump cycle to be employed for the heating unit 38. In this case, the same system can be used for both the heating unit 38 and the cooling unit 36.

Note that the structure of the air conditioning unit 30 is not limited to the structure described above, and it is also possible for some other structure to be employed.

(Seat Air Conditioning Unit 40)

The seat air conditioning unit 40 is an air conditioning unit that is provided respectively in both the driver's seat 110 and the front passenger's seat 112, which are serving as vehicle seats. Because the seat air conditioning unit 40 that is provided in the driver's seat 110 and the seat air conditioning unit 40 that is provided in the front passenger's seat 112 are formed the same way apart from being left-right inverted, the following description is centered on the seat air conditioning unit 40 provided in the driver's seat 110.

As is shown in FIG. 2, the seat air conditioning unit 40 has the air blower 42, a duct 44, an inner side diffuser outlet 47, and an outer side diffuser outlet 49 (see FIG. 5).

The duct 44 is provided inside a seat cushion 133 (i.e., a seating surface portion) and a seat back 135 (i.e., a backrest portion) of the driver's seat 110. More specifically, the duct 44 has a passage 44A (see FIG. 2 and FIG. 5) that extends from a lower side of the seat cushion 133 as far as an intermediate portion in the up-down direction of the seat back 135, and, as is shown in FIG. 5, branch passages 44B and 44C that branch off from a downstream end portion of the passage 44A towards the inner side in the vehicle width direction (i.e. towards the vehicle left side) and towards the outer side in the vehicle width direction (i.e., towards the vehicle right side).

The air blower 42 shown in FIG. 2 is disposed upstream from the duct 44. The air blower 42 feeds (i.e., blows) conditioned air from the air conditioning unit 30 towards the duct 44. As an example, a centrifugal air blower which blows air in centrifugal directions such as a multi vane fan (for example, a sirocco fan) is used as the air blower 42. Note that it is also possible for an axial air blower which blows air in an axial direction to be used as the air blower 42.

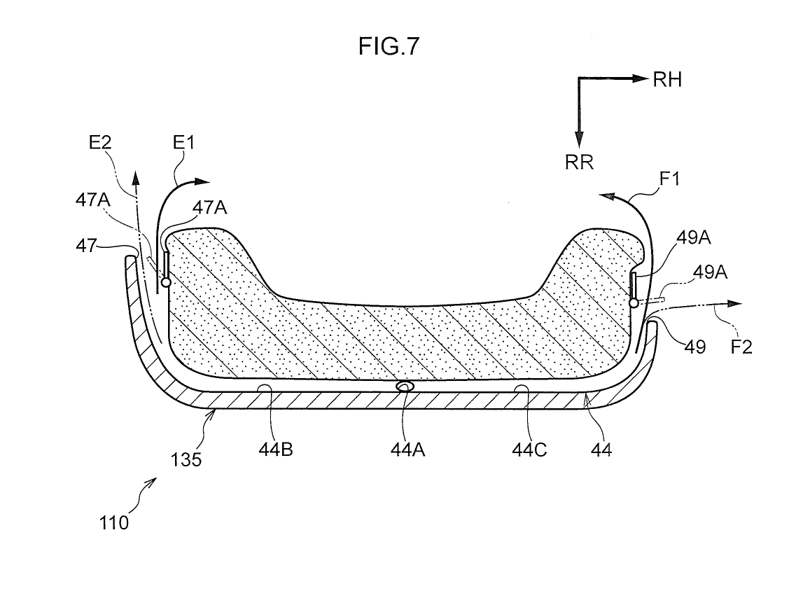

As is shown in FIG. 7, the inner side diffuser outlet 47 is disposed in a side portion on the inner side in the vehicle width direction (i.e. on the vehicle left side) of the seat back 135 of the driver's seat 110. The inner side diffuser outlet 47 communicates with the branch passage 44B, and conditioned air that has been distributed through the branch passage 44B is blown out from the inner side diffuser outlet 47.

The outer side diffuser outlet 49 is disposed in a side portion on the outer side in the vehicle width direction (i.e. on the vehicle right side) of the seat back 135 of the driver's seat 110. The outer side diffuser outlet 49 communicates with the branch passage 44C, and conditioned air that has been distributed through the branch passage 44C is blown out from the outer side diffuser outlet 49.

Wind direction flaps 47A and 49A which are able to alter wind direction are provided in the inner side diffuser outlet 47 and the outer side diffuser outlet 49. The inner side diffuser outlet 47 is able to switch the wind direction using the wind direction flaps 47A between a first direction (i.e., a direction indicated by an arrow E1 in FIG. 5 and FIG. 7) in which air is blown towards a vehicle occupant seated in the driver's seat 110, and a second direction (i.e., a direction indicated by an arrow E2 in FIG. 6 and FIG. 7) in which air is blown in the vehicle forward direction towards the instrument panel 102, which is serving as an interior finishing material of the vehicle 100. Note that the air that is blown in the first direction from the inner side diffuser outlet 47 flows to the vehicle occupant along the seat back 135 in accordance with the Coanda effect.

The outer side diffuser outlet 49 is able to switch the wind direction using the wind direction flaps 49A between a first direction (i.e., a direction indicated by an arrow F1 in FIG. 5 and FIG. 7) in which air is blown towards a vehicle occupant seated in the driver's seat 110, and a second direction (i.e., a direction indicated by an arrow F2 in FIG. 6 and FIG. 7) in which air is blown in the vehicle right side direction towards the door trim 107 on the vehicle right side. Note that the air that is blown in the first direction from the outer side diffuser outlet 49 flows to the vehicle occupant along the seat back 135 in accordance with the Coanda effect.

In the seat air conditioning unit 40 provided in the front passenger's seat 112, the inner side diffuser outlet 47 is able to switch the wind direction using the wind direction flaps 47A between a first direction (i.e., a direction indicated by an arrow G1 in FIG. 5) in which air is blown towards a vehicle occupant seated in the front passenger's seat 112, and a second direction (i.e., a direction indicated by an arrow G2 in FIG. 6) in which air is blown in the vehicle forward direction towards the instrument panel 102. Additionally, the outer side diffuser outlet 49 is able to switch the wind direction using the wind direction flaps 49A between a first direction (i.e., a direction indicated by an arrow H1 in FIG. 5) in which air is blown towards a vehicle occupant seated in the front passenger's seat 112, and a second direction (i.e., a direction indicated by an arrow H2 in FIG. 6) in which air is blown in the vehicle left side direction towards the door trim 107 on the vehicle left side.

Note that conditioned air from the air conditioning unit 30 is supplied to the seat air conditioning unit 40, however, it is also possible to employ a structure in which conditioned air is generated inside the seat air conditioning unit 40 independently of the air conditioning unit 30, and this conditioned air is blown into the vehicle interior. More specifically, it is also possible to employ a structure in which, for example, air supplied from the air blower 42 is cooled or warmed (i.e., heated) using a heat exchanger such as a Peltier heat exchanger or the like. Note that the structure of the seat air conditioning unit 40 is not limited to the structure described above, and some other structure may also be employed.

(First Air Conditioning and Second Air Conditioning in the Air Conditioner Unit 12)

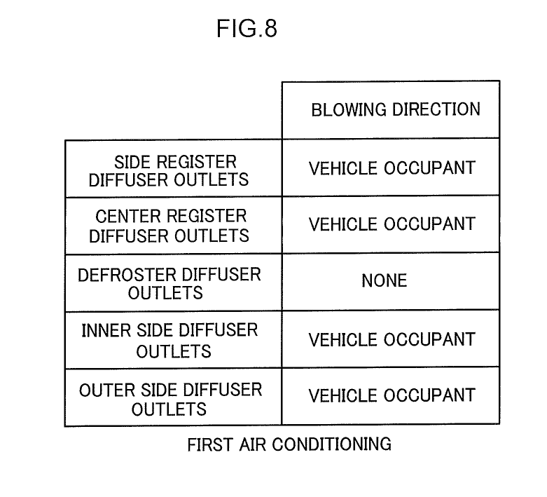

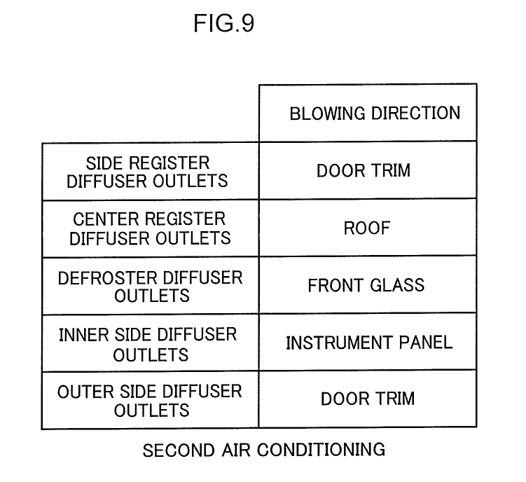

Here, the air conditioner unit 12 is able to execute the first air conditioning (see FIG. 2, FIG. 5, and FIG. 8) in which air is blown towards vehicle occupants seated in the driver's seat 110 and the front passenger's seat 112, and the second air conditioning (see FIG. 3, FIG. 6, and FIG. 9) in which air is blown towards the front glass 104, the roof 106, the door trims 107, and the instrument panel 102. The front glass 104, the roof 106, the door trims 107, and the instrument panel 102 are examples of interior finishing materials of the vehicle 100.

More specifically, as is shown in FIG. 2, in the first air conditioning, the defroster diffuser outlets 33 of the air conditioner unit 12 are closed by the opening/closing portion 335. As a consequence, the blowing of conditioned air from the defroster diffuser outlets 33 is stopped.

Furthermore, as is shown in FIG. 5, in the first air conditioning, the wind directions of the first center register diffuser outlet 371 (see FIG. 2) and the first side register diffuser outlet 391 are set to the first directions (i.e., the direction shown by the arrow A1 and the direction shown by the arrow C1) in which air is blown towards a vehicle occupant seated in the driver's seat 110 by the wind direction flaps 373 and 393. Additionally, in the first air conditioning, the wind directions of the inner side diffuser outlet 47 and the outer side diffuser outlet 49 of the driver's seat 110 are set to the first directions (i.e., the direction shown by the arrow E1 and the direction shown by the arrow F1) in which air is blown towards a vehicle occupant seated in the driver's seat 110 by the wind direction flaps 47A and 49A (see FIG. 7).

As a result, conditioned air is blown towards the vehicle occupant seated in the driver's seat 110 from the first center register diffuser outlet 371 and the first side register diffuser outlet 391, and from the inner side diffuser outlet 47 and the outer side diffuser outlet 49 of the driver's seat 110.

Moreover, as is shown in FIG. 5, in the first air conditioning, the wind directions of the second center register diffuser outlet 372 and the second side register diffuser outlet 392 are set to the first directions (i.e., the direction shown by the arrow B1 and the direction shown by the arrow D1) in which air is blown towards a vehicle occupant seated in the front passenger's seat 112 by the wind direction flaps 374 and 394. Additionally, in the first air conditioning, the wind directions of the inner side diffuser outlet 47 and the outer side diffuser outlet 49 of the front passenger's seat 112 are set to the first directions (i.e., the direction shown by the arrow G1 and the direction shown by the arrow H1) in which air is blown towards a vehicle occupant seated in the front passenger's seat 112 by the wind direction flaps 47A and 49A.

As a result, conditioned air is blown towards the vehicle occupant seated in front passenger's seat 112 from the second center register diffuser outlet 372 and the second side register diffuser outlet 392, and from the inner side diffuser outlet 47 and the outer side diffuser outlet 49 of the front passenger's seat 112.

In this way, in the first air conditioning, the air conditioner unit 12 blows conditioned air towards vehicle occupants (see FIG. 8) from the respective diffuser outlets (i.e., the center register diffuser outlets 37, the side register diffuser outlets 39, the inner side diffuser outlet 47, and the outer side diffuser outlet 49).

Note that when no vehicle occupant is seated in the front passenger's seat 112, the conditioned air blown from the second center register diffuser outlet 372 and the second side register diffuser outlet 392, and from the inner side diffuser outlet 47 and the outer side diffuser outlet 49 of the front passenger's seat 112 is fed to the front passenger's seat 112 which is serving as an interior finishing material. Moreover, when no vehicle occupant is seated in the front passenger's seat 112, the wind directions of the second center register diffuser outlet 372 and the second side register diffuser outlet 392, and from the inner side diffuser outlet 47 and the outer side diffuser outlet 49 of the front passenger's seat 112 may be set, for example, to the second directions (i.e., the direction indicated by the arrow B2, the direction indicated by the arrow D2, the direction indicated by the arrow G2, and the direction indicated by the arrow H2). In this way, in the first air conditioning, it is possible, in a portion of the diffuser outlets, for conditioned air to be blown towards interior finishing materials.

In contrast, as is shown in FIG. 3, in the second air conditioning, the defroster diffuser outlets 33 of the air conditioner unit 12 are opened by the opening/closing portion 335. As a consequence, conditioned air is blown from the defroster diffuser outlets 33 in the vehicle upward direction towards the front glass 104 (i.e., in the direction indicated by the arrow X).

Furthermore, as is shown in FIG. 6, in the second air conditioning, the wind directions of the first center register diffuser outlet 371 (see FIG. 3) and the second center register diffuser outlet 372 are set to the second directions (i.e., the direction shown by the arrow A2 and the direction shown by the arrow B2) in which air is blown in the vehicle upward direction towards the roof 106 by the wind direction flaps 373 and 374. As a result, conditioned air is blown in the vehicle upward direction towards the roof 106 from the first center register diffuser outlet 371 and the second center register diffuser outlet 372.

Moreover, in the second air conditioning, the wind directions of the outer side diffuser outlet 49 of the driver's seat 110 and the first side register diffuser outlet 391 are set to the second directions (i.e., the direction shown by the arrow F2 and the direction shown by the arrow C2) in which air is blown in the vehicle right side direction towards the door trim 107 on the vehicle right side by the wind direction flaps 49A (see FIG. 7) and the wind direction flaps 393. As a result, conditioned air is blown in the vehicle right side direction towards the door trim 107 on the vehicle right side from the outer side diffuser outlet 49 of the driver's seat 110 and the first side register diffuser outlet 391.

Moreover, in the second air conditioning, the wind directions of the outer side diffuser outlet 49 of the front passenger's seat 112 and the second side register diffuser outlet 392 are set to the second directions (i.e., the direction shown by the arrow H2 and the direction shown by the arrow D2) in which air is blown in the vehicle left side direction towards the door trim 107 on the vehicle left side by the wind direction flaps 49A (see FIG. 7) and the wind direction flaps 394. As a result, conditioned air is blown in the vehicle left side direction towards the door trim 107 on the vehicle left side from the outer side diffuser outlet 49 of the front passenger's seat 112 and the second first side register diffuser outlet 392.

Moreover, in the second air conditioning, the wind directions of the inner side diffuser outlet 47 of the driver's seat 110 and the inner side diffuser outlet 47 of the front passenger's seat 112 are set to the second directions (i.e., the direction shown by the arrow E2 and the direction shown by the arrow G2) in which air is blown in the vehicle forward direction towards the instrument panel 102 by the wind direction flaps 47A (see FIG. 7). As a result, conditioned air is blown in the vehicle forward direction towards the instrument panel 102 from the inner side diffuser outlet 47 of the driver's seat 110 and the inner side diffuser outlet 47 of the front passenger's seat 112.

In this way, in the second air conditioning, the air conditioner unit 12 blows conditioned air towards interior finishing materials (i.e., the front glass 104, the roof 106, the door trims 107, and the instrument panel 102) of the vehicle 100 (see FIG. 9) from the respective diffuser outlets (i.e., the defroster diffuser outlets 33, the center register diffuser outlets 37, the side register diffuser outlets 39, the inner side diffuser outlets 47, and the outer side diffuser outlets 49).

Moreover, in this way, in the second air conditioning, the air conditioner unit 12 alters the wind directions of the respective diffuser outlets (i.e., the center register diffuser outlets 37, the side register diffuser outlets 39, the inner side diffuser outlets 47, and the outer side diffuser outlets 49) to different blowing directions from the blowing directions employed in the first air conditioning using the wind direction flaps 373, 374, 393, 394, 47A, and 49A. In other words, the wind direction flaps 373, 374, 393, 394, 47A, and 49A are an example of altering components that alter wind directions in the second air conditioning to different blowing directions from the blowing directions employed in the first air conditioning. Note that the wind directions of the wind direction flaps 373, 374, 393, 394, 47A, and 49A are altered by driving a drive unit such as a motor or the like.

Moreover, the interior furnishing materials of the vehicle 100 onto which air is blown in the second air conditioning are not limited to those described above. For example, a center console located between the driver's seat 110 and the front passenger's seat 112, pillar trims, and vehicle seats such as the driver's seat 110 and the front passenger's seat 112 may also serve as interior furnishing materials of the vehicle 100 onto which air is blown.

Note also that when the objects onto which air is blown in the second air conditioning are the driver's seat 110 and the front passenger's seat 112, then a structure can be employed in the second air conditioning in which, for example, the blowing directions of the inner side diffuser outlets 47 and the outer side diffuser outlets 49 of the driver's seat 110 and the front passenger's seat 112 are made the same as the blowing directions in the first air conditioning, so that conditioned air is blown towards the driver's seat 110 and the front passenger's seat 112 which are serving as interior finishing materials. In this way, it is also possible for the blowing directions in the second air conditioning to be partially the same as the blowing directions in the first air conditioning.

(Air Conditioner Control Unit 16)

The air conditioner control unit 16 is an example of a control unit that causes the air conditioner unit to execute the first air conditioning in a first case, which is when a vehicle occupant has not boarded the vehicle, and causes the air conditioner unit to execute the second air conditioning in a second case, which is when no vehicle occupant has boarded the vehicle.

As is shown in FIG. 1, an internal operating unit 90A that is used to operate the air conditioner unit 12 when the operator (i.e., a vehicle occupant) is inside the vehicle, and an external operating unit 90B that is used to operate the air conditioner unit 12 when the operator is outside the vehicle are connected to the air conditioner control unit 16.

The internal operating unit 90A is formed by an operating panel provided in the instrument panel 102 of a vehicle. The external operating unit 90B is formed by an operating terminal that is connected to the air conditioner control unit 16 via, for example, a communication network such as the Internet or the like. For example, a smartphone or the like may be used as this operating terminal. Note that in the following description the internal operating unit 90A and the external operating unit 90B are collectively referred to as an operating unit 90.

The operating unit 90 is able to execute an ON operation which drives (i.e., operates) the air conditioner unit 12, and an OFF operation which stops the driving (i.e., the operation) of the air conditioner unit 12. Furthermore, as an example, the operating unit 90 is also able to execute a selection operation to select either a cooling operation or a heating operation in the air conditioner unit 12.

An operation result from the operating unit 90 is sent to the air conditioner control unit 16. Consequently, the air conditioner control unit 16 acquires the operation result, and drives (i.e., operates) each unit of the air conditioner unit 12 based on the operation result. More specifically, if the air conditioner control unit 16 acquires an operation result showing that an ON operation has been executed, it causes power to be supplied from the secondary cell 152 to each unit of the air conditioner unit 12, and thus causes the air conditioner unit 12 to be driven. At this time, the air conditioner control unit 16 causes the air conditioner unit 12 to execute the cooling operation or heating operation selected in the operating unit 90. Conversely, if the air conditioner control unit 16 acquires an operation result showing that an OFF operation has been executed, it causes the driving of the air conditioner unit 12 to stop. Note that it is also possible to employ a structure in which, irrespective of the operation performed on the operating unit 90, the air conditioner control unit 16 selects one of a cooling operation or a heating operation based on information such as the vehicle interior temperature and the vehicle exterior temperature.

A seating sensor 98, which serves as a detection unit that detects whether a vehicle occupant has sat down in the driver's seat 110, is connected to the air conditioner control unit 16. As a consequence, when a vehicle occupant sits in the driver's seat 110, a seating detection signal is sent from the seating detection sensor 98 to the air conditioner control unit 16, and the air conditioner control unit 16 acquires this seating detection signal. If no vehicle occupant has sat in the driver's seat 110, then no seating detection signal is sent from the seating detection sensor 98 to the air conditioner control unit 16. The seating detection sensor 98 is provided, for example, in the seat cushion 133 of the driver's seat 110, and is formed by a sensor that detects that a vehicle occupant is sitting down when a load is applied to the seat surface of the seat cushion 133.

A temperature sensor 99 which serves as a detecting unit that detects the vehicle interior temperature is connected to the air conditioner control unit 16. More specifically, for example, during a cooling operation, if the vehicle interior temperature in the temperature sensor 99 reaches a reference temperature, namely, if the vehicle interior temperature exceeds this reference temperature, a temperature detection signal is sent from the temperature sensor 99 to the air conditioner control unit 16, and the air conditioner control unit 16 acquires this temperature detection signal. When the vehicle interior temperature is less than the reference temperature, no temperature detection signal is sent from the temperature sensor 99 to the air conditioner control unit 16. As an example, the reference temperature is set to a minimum temperature at which a vehicle occupant feels that the vehicle interior is uncomfortably hot (for example, within a range of 26° or more to 32° or less).

Note that, during a heating operation, if, for example, the vehicle interior temperature in the temperature sensor 99 drops below the reference temperature, a temperature detection signal is sent from the temperature sensor 99 to the air conditioner control unit 16, and the air conditioner control unit 16 acquires this temperature detection signal. If the vehicle interior temperature exceeds the reference temperature, no temperature detection signal is sent from the temperature sensor 99 to the air conditioner control unit 16. As an example, the reference temperature is set to a maximum temperature at which a vehicle occupant feels that the vehicle interior is uncomfortably cold (for example, within a range of 15° or more to 25° or less).

Here, the air conditioner control unit 16 is initially set to an auto mode in which the selection of the above-described first air conditioning or the above-described second air conditioning is executed automatically. Note that it is also possible to enable the air conditioner control unit 16 to be altered to a manual mode in which this selection is executed manually.

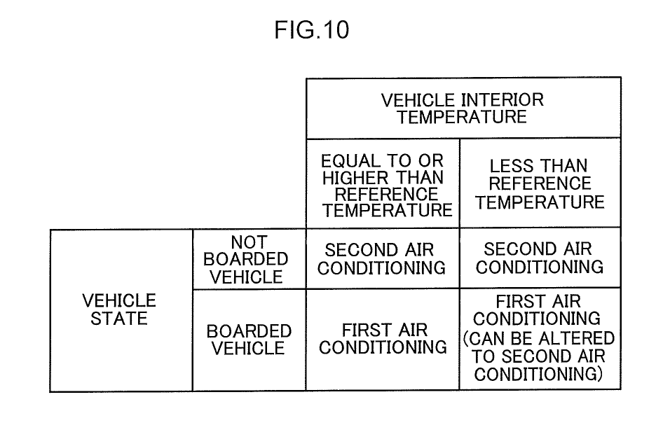

In the present exemplary embodiment, as is shown in FIG. 10, when a vehicle occupant has boarded the vehicle (i.e., in the first case) and the vehicle interior temperature has satisfied predetermined temperature conditions, the air conditioner control unit 16 causes the air conditioner 12 to execute the first air conditioning. In other words, when the air conditioner control unit 16 acquires an operation result for an ON operation from the operating unit 90, then if the air conditioner control unit 16 has acquired a seating detection signal from the seating sensor 98 and has also acquired a temperature detection signal from the temperature sensor 99, the air conditioner control unit 16 causes the air conditioner unit 12 to execute the first air conditioning. Note that during a cooling operation, the aforementioned ‘the vehicle interior temperature has satisfied predetermined temperature conditions’ means ‘the vehicle interior temperature is equal to or greater than the reference temperature’, while during a heating operation, it means ‘the vehicle interior temperature is equal to or less than the reference temperature’.

Moreover, when a vehicle occupant has boarded the vehicle (i.e., in the first case) and the vehicle interior temperature has not satisfied predetermined temperature conditions, the air conditioner control unit 16, for example, causes the air conditioner 12 to execute the first air conditioning, and also makes it possible for the air conditioner 12 to be altered to the second air conditioning. In other words, when the air conditioner control unit 16 acquires an operation result for an ON operation from the operating unit 90, then if the air conditioner control unit 16 has acquired a seating detection signal from the seating sensor 98 but has not acquired a temperature detection signal from the temperature sensor 99, the air conditioner control unit 16 causes the air conditioner unit 12 to execute the first air conditioning, and also, for example, causes a message indicating that an alteration to the second air conditioning is possible to be displayed on an operation panel which is serving as the internal operating unit 90A. If an alteration operation (i.e., a selection operation) is then performed via the internal operating unit 90A commanding that the operation be altered to the second air conditioning, the air conditioner control unit 16 causes the air conditioner unit 12 to execute the second air conditioning.

Note that it is also possible to employ a structure in which, when a vehicle occupant has boarded the vehicle (i.e., in the first case) and the vehicle interior temperature has not satisfied predetermined temperature conditions, the air conditioner control unit 16 causes the air conditioner 12 to execute the second air conditioning, and also makes it possible for the air conditioner 12 to be altered to the first air conditioning. In this case, once either the first air conditioning or the second air conditioning has been selected by a vehicle occupant, the selected air conditioning is executed.

Moreover, during a cooling operation, the aforementioned ‘the vehicle interior temperature has not satisfied predetermined temperature conditions’ means ‘the vehicle interior temperature is less than the reference temperature’, while during a heating operation, it means ‘the vehicle interior temperature exceeds the reference temperature’.

Furthermore, when no vehicle occupant has boarded the vehicle (i.e., in the second case), then the air conditioning control unit 16 causes the air conditioner unit 12 to execute the second air conditioning irrespective of the vehicle interior temperature. In other words, when the air conditioner control unit 16 acquires an operation result for an ON operation from the operating unit 90, then if the air conditioner control unit 16 has not acquired a seating detection signal from the seating sensor 98, the air conditioning control unit 16 causes the air conditioner unit 12 to execute the second air conditioning irrespective of whether or not a temperature detection signal has been acquired from the temperature sensor 99.

Note that it is also possible for the same control unit to be used for both the air conditioner control unit 16 and the above-described vehicle control unit 154.

(Actions and Effects of the Present Exemplary Embodiment)

Actions and effects of the present exemplary embodiment will now be described.

Here, a case in which, for example, during the summer season, a person using the vehicle 100 (hereinafter, referred to as a user) cools down the vehicle interior prior to boarding the vehicle will be described.

The user performs, for example, an ON operation, and also selects a cooling operation for the air conditioner unit 12 via the external operating unit 90B. When the air conditioning control unit 16 acquires this operation result, the air conditioner control unit 16 causes power to be supplied from the secondary cell 152 to each unit of the air conditioner unit 12 so as to drive the air conditioner unit 12, and causes the air conditioner unit 12 to execute a cooling operation.

Here, because the user has not yet boarded the vehicle 100, namely, because no vehicle occupant is sitting down in the vehicle, the air conditioner control unit 16 has not acquired a seating detection signal from the seating sensor 98. Because of this, the air conditioner control unit 16 causes the air conditioner unit 12 to execute the second air conditioning regardless of the vehicle interior temperature (see FIG. 10).

As is shown in FIG. 6, in the second air conditioning, the air conditioner unit 12 blows conditioned air from the defroster diffuser outlets 33 in the vehicle upward direction (i.e., in the direction indicated by the arrow X) towards the front glass 104. Additionally, conditioned air is also blown from the first center register diffuser outlet 371 and the second center register diffuser outlet 372 in the vehicle upward direction towards the roof 106. Furthermore, conditioned air is also blown from the outer side diffuser outlet 49 of the driver's seat 110 and the first side register diffuser outlet 391 in the vehicle right side direction towards the door trim 107 on the vehicle right side. In addition, conditioned air is also blown from the outer side diffuser outlet 49 of the front passenger's seat 112 and the second side register diffuser outlet 392 in the vehicle left side direction towards the door trim 107 on the vehicle left side. Moreover, conditioned air is also blown from the inner side diffuser outlet 47 of the driver's seat 110 and from the inner side diffuser outlet 47 of the front passenger's seat 112 in the vehicle forward direction towards the instrument panel 102.

In this way, in the second air conditioning, the air conditioner unit 12 blows conditioned air towards the front glass 104, the roof 106, the door trims 107, and the instrument panel 102 (hereinafter, these are referred to as the interior finishing materials of the vehicle 100). As a result, the interior finishing materials of the vehicle 100 can be cooled down prior to the user boarding the vehicle. By cooling down the interior finishing materials of the vehicle 100 prior to the user boarding the vehicle, the hot sensation which is created by the radiant heat arising from the interior finishing materials of the vehicle 100 and is felt by a user who boards the vehicle 100 can be reduced.

Moreover, when a user boards the vehicle 100, namely, when a user sits on the driver's seat 110, the air conditioner control unit 16 acquires a seating detection signal from the seating sensor 98, and if the air conditioner control unit 16 additionally acquires a temperature detection signal from the temperature sensor 99, then the air conditioner control unit 16 causes the air conditioner unit 12 to execute the first air conditioning. Note that if the air conditioner control unit 16 acquires the seating detection signal from the seating sensor 98, but does not acquire a temperature detection signal from the temperature sensor 99, then it causes the air conditioner unit 12 to execute the first air conditioning and also, for example, displays a message indicating that an alteration to the second air conditioning is possible on an operation panel which is serving as the internal operating unit 90A.

As is shown in FIG. 5, in the first air conditioning, the blowing of conditioned air by the air conditioner unit 12 from the defroster diffuser outlets 33 is stopped. In addition, in the first air conditioning, conditioned air is blown from the first center register diffuser outlet 371 and the first side register diffuser outlet 391, and also from the inner side diffuser outlet 47 and the outer side diffuser outlet 49 of the driver's seat 100 towards a user (hereinafter, referred to as a vehicle occupant) seated in the driver's seat 100. Note that, in a cooling operation, it is desirable that this conditioned air be blown towards the upper half of the vehicle occupant's body.

Moreover, in the first air conditioning, conditioned air is blown in the first directions (.e., the direction shown by the arrow B1, the direction shown by the arrow D1, the direction shown by the arrow G1, and the direction shown by the arrow H1) from the second center register diffuser outlet 372 and the second side register diffuser outlet 392, and from the inner side diffuser outlet 47 and the outer side diffuser outlet 49 of the front passenger's seat 112. As a result, when a vehicle occupant is seated in the front passenger's seat 112, conditioned air is blown towards this vehicle occupant.

As is described above, in the present exemplary embodiment, because conditioned air is blown towards a vehicle occupant, the peripheral temperature around that vehicle occupant can be cooled efficiently and in a shorter time than when air is blown in a direction where there is no vehicle occupant.

Note that, for example, in the winter season, the same actions and effects are obtained when a user performs a heating operation to warm the interior of the vehicle 100 prior to the user boarding the vehicle. In other words, when no user has yet boarded the vehicle 100, by blowing air towards the interior finishing materials of the vehicle 100, the air conditioner unit 12 is able to warm (i.e. heat) the interior finishing materials of the vehicle 100 prior to a user boarding the vehicle. By warming the interior finishing materials of the vehicle 100 prior to a user boarding the vehicle, the cold sensation which is imparted from the interior finishing materials of the vehicle 100 and is felt by a user who boards the vehicle 100 can be reduced. Additionally, because conditioned air is blown towards a user (i.e., a vehicle occupant) when the vehicle occupant has boarded the vehicle 100, the peripheral temperature around that vehicle occupant can be raised efficiently and in a shorter time than when air is blown in a direction where there is no vehicle occupant. Note that, in a heating operation, it is desirable that this conditioned air be blown towards the lower half of the vehicle occupant's body.

Consequently, according to the air conditioner 10 for a vehicle according to the present exemplary embodiment, it is possible to quickly adjust the peripheral temperature around a vehicle occupant, at the same time as hot or cold sensations imparted to the vehicle occupant from the interior finishing materials of the vehicle 100 are reduced.

Moreover, in the present exemplary embodiment, in the second air conditioning, the air conditioner unit 12 blows air in a different blowing direction from the blowing direction employed in the first air conditioning. Because of this, in the second air conditioning, it is possible to cool or heat interior finishing materials disposed in a different direction from the seating position where a vehicle occupant is seated in the vehicle 100.

Moreover, in the present exemplary embodiment, in the second air conditioning, the air conditioner unit 12 alters the wind directions of the respective diffuser outlets (i.e., the center register diffuser outlets 37, the side register diffuser outlets 39, the inner side diffuser outlets 47, and the outer side diffuser outlets 49) to different blowing directions from the blowing directions employed in the first air conditioning using the wind direction flaps 373, 374, 393, 394, 47A, and 49A.

Here, if the wind direction flaps 373, 374, 393, 394, 47A, and 49A are not provided, because it then becomes necessary to blow air in the first air conditioning from diffuser outlets facing in a different direction from the diffuser outlets employed in the second air conditioning, it becomes necessary to provide both diffuser outlets for the first air conditioning and diffuser outlets for the second air conditioning.

In contrast to this, in the present exemplary embodiment, because the wind direction flaps 373, 374, 393, 394, 47A, and 49A alter the wind direction to a different blowing direction from the blowing direction employed in the first air conditioning, air can be blown from the same diffuser outlets in both the first air conditioning and the second air conditioning.

### Variant Example

In the present exemplary embodiment, when the air conditioner control unit 16 has not acquired a seating detection signal from the seating sensor 98, then the air conditioner control unit 16 causes the air conditioner unit 12 to execute the second air conditioning as the air conditioning for a case in which no vehicle occupant is on board the vehicle (i.e., as the second case), however, the present disclosure is not limited to this. For example, it is also possible to employ a structure in which, if an operation has been executed on the external operating unit 90B, then the air conditioner control unit 16 causes the air conditioner unit 12 to execute the second air conditioning as the second case. In this structure, the air conditioner unit 12 can be made to execute the second air conditioning irrespective of whether or not a detection result from the seating sensor 98 has been acquired.

Moreover, while the secondary cell 152 is being charged, it is also possible for the air conditioner control unit 16 to cause the air conditioner unit 12 to execute the second air conditioning as the second case. In this structure, the air conditioner unit 12 can be made to execute the second air conditioning irrespective of whether or not a detection result from the seating sensor 98 has been acquired. Furthermore, in this structure, because the second air conditioning is executed while the secondary cell 152 is being charged, it is possible to replenish the power in the secondary cell 152 that is consumed as a result of the second air conditioning being executed. Because of this, even if the vehicle 100 is an electric vehicle that runs on power stored in the secondary cell 152, there is no effect on the travel distance of this vehicle. In this way, in the present exemplary embodiment, it is also possible to employ a structure in which conditioned air is blown onto interior finishing materials in the vehicle 100 when it is predicted that a vehicle occupant will not board the vehicle 100.

In the present exemplary embodiment, the air conditioner control unit 16 detects that a vehicle occupant has boarded the vehicle 100 when it is detected by the seating sensor 98 that a vehicle occupant has sat in the driver's seat 110, however, the present disclosure is not limited to this. For example, it is also possible for a boarding of the vehicle 100 by a vehicle occupant to be detected as a result of an operation (for example, an operation to drive the motor 150) being input into the internal operating unit 90A.

Furthermore, when a control system (i.e., a scheduler) that controls operations relating to an intention of a user to board the vehicle 100 is connected to the air conditioner control unit 16, then, for example, the following type of structure may be employed. Namely, at a predetermined length of time prior to a planned boarding time when a user plans to board the vehicle 100, this control system notifies a user that this planned boarding time will arrive after the predetermined time, and also sends a signal to the air conditioner control unit 16 that the current time is the predetermined length of time prior to the planned boarding time. The air conditioner control unit 16 regards a case in which this signal has been acquired as a case in which a vehicle occupant has not boarded the vehicle (i.e., as the second case), and causes the air conditioner unit 12 to execute the second air conditioning. Subsequently, this control system sends a signal announcing that the planned boarding time has arrived to the air conditioner control unit 16. The air conditioner control unit 16 regards a case in which this signal has been acquired as a case in which a vehicle occupant has boarded the vehicle (i.e., as the first case), and causes the air conditioner unit 12 to execute the first air conditioning.

The present disclosure is not limited to the above-described exemplary embodiments, and various additions, modifications, and improvements may be made thereto insofar as they do not depart from the spirit or scope of the present disclosure.

What is claimed is:

1. An air conditioner for a vehicle comprising:
an air conditioner unit that is configured to execute first air conditioning in which air is blown towards a vehicle occupant who has boarded a vehicle, and second air conditioning in which air is blown towards interior finishing materials of the vehicle; and
a control unit that causes the air conditioner unit to execute the first air conditioning in a first case, which is when a vehicle occupant has boarded the vehicle, and causes the air conditioner unit to execute the second air conditioning in a second case, which is when no vehicle occupant has boarded the vehicle.

2. The air conditioner for a vehicle according to claim 1, wherein,
in the first case, the control unit causes the air conditioner unit to execute the first air conditioning when the vehicle interior temperature satisfies predetermined temperature conditions, and,
when the vehicle interior temperature does not satisfy predetermined temperature conditions in the first case, the control unit causes the air conditioner unit to execute one of the first air conditioning or the second air conditioning based on a selection made by a vehicle occupant, and,
in the second case, the control unit causes the air conditioner unit to execute the second air conditioning irrespective of the vehicle interior temperature.

3. The air conditioner for a vehicle according to claim 1, wherein,
when an operation to drive the air conditioner unit has been performed outside a vehicle, the control unit causes the air conditioner unit to execute, as the second case, the second air conditioning.

4. The air conditioner for a vehicle according to claim 2, wherein,
when an operation to drive the air conditioner unit has been performed outside a vehicle, the control unit causes the air conditioner unit to execute, as the second case, the second air conditioning.

5. The air conditioner for a vehicle according to claim 1, wherein
the air conditioner unit executes the first air conditioning and the second air conditioning using power from a secondary cell that is provided in a vehicle, and,
when charging the secondary cell, the control unit causes the air conditioner unit to execute, as the second case, the second air conditioning.

6. The air conditioner for a vehicle according to claim 2, wherein
the air conditioner unit executes the first air conditioning and the second air conditioning using power from a secondary cell that is provided in a vehicle, and,
when charging the secondary cell, the control unit causes the air conditioner unit to execute, as the second case, the second air conditioning.

7. The air conditioner for a vehicle according to claim 1, wherein, in the second air conditioning, the air conditioner unit blows air in a different blowing direction from the blowing direction employed in the first air conditioning.

8. The air conditioner for a vehicle according to claim 2, wherein, in the second air conditioning, the air conditioner unit blows air in a different blowing direction from the blowing direction employed in the first air conditioning.

9. The air conditioner for a vehicle according to claim 3, wherein, in the second air conditioning, the air conditioner unit blows air in a different blowing direction from the blowing direction employed in the first air conditioning.

10. The air conditioner for a vehicle according to claim 5, wherein, in the second air conditioning, the air conditioner unit blows air in a different blowing direction from the blowing direction employed in the first air conditioning.

11. The air conditioner for a vehicle according to claim 7, wherein the air conditioner unit has altering components that, in the second air conditioning, alter the wind direction to a different blowing direction from the blowing direction employed in the first air conditioning.

12. The air conditioner for a vehicle according to claim 8, wherein the air conditioner unit has altering components that, in the second air conditioning, alter the wind direction to a different blowing direction from the blowing direction employed in the first air conditioning.

13. The air conditioner for a vehicle according to claim 9, wherein the air conditioner unit has altering components that, in the second air conditioning, alter the wind direction to a different blowing direction from the blowing direction employed in the first air conditioning.

14. The air conditioner for a vehicle according to claim 10, wherein the air conditioner unit has altering components that, in the second air conditioning, alter the wind direction to a different blowing direction from the blowing direction employed in the first air conditioning.
